(19) United States
(12) Patent Application Publication
(10) Pub. No.: US 2016/0035525 A1
(43) Pub. Date: Feb. 4, 2016

(54) PRINTED MEMBRANE SWITCH ACTIVATED WITH MAGNETIC FORCE AND APPLICATIONS THEREOF

(71) Applicant: MOLEX, LLC, Lisle, IL (US)

(72) Inventor: David G. SIME, North Mankato, MN (US)

(73) Assignee: MOLEX, LLC, Lisle, IL (US)

(21) Appl. No.: 14/776,511

(22) PCT Filed: Mar. 13, 2014
(86) PCT No.: PCT/US14/26121

§ 371 Date: Sep. 14, 2015

Related U.S. Application Data
(60) Provisional application No. 61/782,540, filed on Mar. 14, 2013.

(51) Int. Cl. H01H 51/01

(52) U.S. Cl. CPC H01H 51/01

(57) ABSTRACT

A magnetically actuated membrane switch shiftable between a rest or unmagnetized state, and an activated or magnetized state in the presence of a magnetic field. The membrane switch generally includes first and second conductive traces shiftable between a closed position wherein the conductive traces are electrically connected to make a circuit, and an open position wherein the conductive traces are electrically isolate to break a circuit. The membrane switch further includes a magnetic material that is activated by a magnetic field, thereby effecting a switching operation from a rest position to an activated position, and vice versa.

### RELATED APPLICATION

The present application claims the benefit of U.S. Provisional Application No. 61/782,540, filed Mar. 14, 2013, which is incorporated herein in its entirety by reference.

### TECHNICAL FIELD

The invention relates generally to membrane switches, and more specifically to printed membrane switches activated by a magnetic force.

### BACKGROUND OF THE INVENTION

Switches typically are electrically or manually controlled two-state devices that operate to open and close conductive elements or contacts in circuitry, thereby effecting the operation of the circuitry or at least a portion of the circuitry. For example, a switch operates to open or form a circuit by interrupting the current, or diverting it from one conductor to another, or allowing current to flow along or between conductors. A switch can also provide a means for redirecting or biasing current flow in circuitry so as to enable or disable the function of another part of the circuitry. Many types of switches exist, including, for example, electromechanical devices (e.g. light switches), reed switches, relays, latching switches, and membrane switches to name a few.

A relay is an electrical switch that is operated by another electrical circuit. For example, some relays use an electromagnet, or a material in which a magnetic field is produced only in the presence of an electrical field, to actuate the switching mechanism. Relays typically incorporate coils, such that when an electric current is passed through the coil, it generates a magnetic field. In turn, the magnetic field activates a ferrous armature, and the armature either makes or breaks a connection with a fixed contact to either open or close a circuit, depending on the construction. Relays are typically used to control a circuit operating at high power by use of a lower power signal.

A discrete reed switch is an electrical switch operated by an applied magnetic field. In a simple form, a reed switch includes, for example, at least two magnetizable, flexible metal reeds separated on an end of each reed by a small gap when the switch is open. In the presence of a magnetic field induced by an electromagnet or permanent magnet, the reeds are forced together into contact, thereby eliminating the gap and closing the switch to complete an electrical circuit. Alternatively, the reeds are in contact such that the switch is closed, and the presence of a magnetic field forces them apart, thereby opening the switch to break or interrupt the electrical circuit.

A discrete reed switch can include ferrous metal reeds hermetically sealed typically in a glass envelope to protect the reeds from atmospheric corrosion and/or oxidation of the metal reed, which can reduce or negatively affect the conductive properties of the metal. However, the construction and incorporation of these switches into circuitry can be economically infeasible, or inappropriate because of their size and rigidity, thereby limiting their application.

Latching switches are switches that maintain their state once activated, and are returned to their original state only upon a second actuation. For example, a circuit is formed or opened upon a first actuation of the switch, and is then opened or formed, respectively, only upon a second actuation of the switch.

One type of latching switch is described in U.S. Pat. No. 7,215,229, entitled “Laminated Relays with Multiple Flexible Contacts,” hereinafter referred to as “the '229 Patent.” In the '229 Patent, a laminated electro-mechanical system (LEMS) switch includes a “plurality of structural layers [including] at least two structural layers that each include a flexible member. The plurality of structural layers are stacked and aligned into a stack, to form at least one switch. Each structural layer in the stack is attached to an adjacent structural layer of the stack. When the formed switch is in an ‘on’ state, the first flexible member is in contact with the second flexible member[.]” (Abstract.) The actuation of the first flexible member to a first stable state, e.g. the first flexible member is in contact with the second flexible member, is accomplished via a permanent magnet layer that produces a magnetic field to induce a magnetization of a magnetic material of the first flexible member. A second magnetic field opposite the first magnetic field is produced via an electromagnet or coil, and upon actuation by application of a current to the coil, the first flexible member returns to the second stable state, e.g. the first flexible member is not in contact with the second flexible member.

Although the laminated layers provide added simplicity to latching switches such that they can be incorporated into a wider variety of applications, latching switches remain somewhat complex due to the latching function of the switch, and it may be uneconomical to incorporate them into a number of applications, including in lower cost items like packaging.

A simpler, non-latching switch structure is a membrane switch. A membrane switch is an electrical switch that is printed on a flexible substrate such as PET or ITO. Membrane switches are usually actuated by a force applied perpendicular to the substrate to momentarily open or close a corresponding circuit. Membrane switches are typically non-latching switches because they temporarily open or close, more commonly close, the circuit when the force is present.

A membrane switch typically has multiple layers. The top layer of a membrane switch can be a graphic interface between the user and the machine, e.g. a key on a keyboard. Another layer is a printed circuit. This can also be a flex circuit made of copper and polyimide material. For example, referring to FIG. 1A, a membrane switch 10 can include a first layer or substrate 12 having a first conductive trace 14a and a second conductive trace 14b separated by a gap 16. A second layer or substrate 18, spaced from first substrate 12 via a spacer layer 20, contains or holds a conductive trace 22 or shunt. Referring to FIG. 1B, upon application of force F perpendicular to first layer 12 and second layer 18, conductive shunt 22 is forced into contact with each of two traces 14a and 14b to complete the circuit.

Because of their simplicity and flexibility, membrane switches can be less expensive to manufacture than other conventional switches. Nevertheless, common uses of membrane switches remain somewhat limited, such as to computer keyboards, touch screens, and control panels, for example.

Due to the ever increasing flexibility of printed circuit technology, new applications for printed electronics or electronic devices have been contemplated. Applications can include, for example, packaging, wrapping, promotional items, disposable items, signage, clothing, and the like. Electronics can provide novel aesthetic or functional features, such as visual or sound features, to various items as a means to attract a potential consumer or buyer to buy the product or otherwise enhance the value of the product. Electronics can also provide a “smart” feature to display or provide information on the item such as cost, expiration date, temperature, and the like. Electronics are typically battery-powered via small coin cell batteries, or a printed battery.

It can be desirable to maintain battery-powered electronics or circuitry in an “off” or low powered state during transportation, mailing, and/or storage of the item containing the electronics. For example, in the case of packaging incorporating electronics, the time needed for transportation and/or storage may be greater than the battery life, such that if the electronics were to run the entire time, they would no longer be functional or be functional for an undesirable amount of time upon arrival to their destination. It also may be the case that for security, processing, handing or other screening processes, the operation of the electronics may be disruptive and thus disallowed during those processes.

The incorporation of switches into the circuitry of the electronics can function to power off or keep the electronics in a state of low power until they are purposely activated. However, conventional switches are either too complex or too costly to be economically or efficiently incorporated into the printed circuits, or they may not provide the correct functionality, such as the manual membrane switch, or they may not provide a compatible form factor, such as the thin and flexible factor typically associated with mailed items.

There remains a need for a way to maintain a battery-powered circuit in a low or no power state until actuation, and that can be efficiently and economically incorporated into items such as packaging, wrapping, promotional items, disposable items, signage, clothing, and the like.

### SUMMARY

Embodiments overcome many of the above-described deficiencies, and are directed to a printed membrane switch that can be activated by a magnetic force and efficiently and economically produced or incorporated into circuitry.

The magnetically actuated membrane switch according to embodiments is shiftable between a rest or unmagnetized state in the absence of a magnetic field, and an activated, or magnetized, state in the presence of a magnetic field, whether a repulsive field or an attractive field. The membrane switch generally includes first and second conductive traces shiftable between a closed position wherein the conductive traces are electrically connected to close a circuit, and an open position wherein the conductive traces are electrically isolated to open the circuit. Depending on the construction of the switch, the rest state can correspond to either the open position of the circuit or the closed position of the circuit, and the activated state can correspond to the other of the open position or the closed position of the circuit. The membrane switch further includes a magnetic material that is affected (attracted or repulsed) by a magnetic field, thereby effecting the switching operation from the rest state to the activated state in the presence of a magnetic field, and back to the rest state upon removal of the magnetic field.

According to an embodiment, a magnetically actuated membrane switch includes first and second conductive traces printed on a flexible substrate in a first plane and separated by a gap. A second flexible substrate spaced from the first flexible substrate via a spacer layer comprises or contains a conductive shunt. A magnetic material, such as a ferromagnetic material, is incorporated into the shunt itself, is printed proximate the shunt, and or is incorporated into the first layer. Upon application of a magnetic field, such as by the presence of a rare earth magnetic or other magnet, the force acting on the magnetic material causes the flexible substrate having the magnetic material thereon to flex from a first rest state to a second state. Upon removal of the magnetic field, the flexible substrate returns to the rest state.

In one embodiment, in a rest state, the membrane switch is in an open position in which the flexible substrates are spaced apart and the circuit is open. Application of a magnetic field causes the magnetic material to be attracted to the magnet, thereby causing the flexible layer having the magnetic material thereon to flex toward the other flexible layer, such that the conductive shunt bridges the gap between the two conductive traces, thereby closing the circuit.

In an alternative embodiment, in a rest state, the membrane switch is in a closed position in which the first and second flexible substrates are in contact and the conductive shunt bridges the gap between the two conductive traces. Application of a magnetic field forces the flexible substrates away from one another, by placement of the magnet with respect to the magnetic material such that the conductive shunt is removed from the gap between the two conductive traces, thereby opening the circuit. Alternately, in another embodiment, a magnet also may be used in place of the magnetic material in which case it can be arranged to be repulsed by interaction with the external magnet, thus opening the contacts of the membrane switch. In yet another alternative embodiment, the magnetic material comprises a diamagnetic material that is repulsed by interaction with the external magnet, thus opening the contacts of the membrane switch.

An alternative embodiment can comprise a single flexible substrate having first and second conductive traces deposited thereon. One or both of the conductive traces can further comprise a hinged or articulating arm portion having a magnetic material thereon. Interaction of the magnetic material with the magnet causes the articulating arm to either move to a “closed” position by bridging the gap between the conductive traces, or an “open” position by creating the gap between the conductive traces, depending on the configuration of the switch.

Another alternative embodiment can comprise first and second flexible substrates separated by a spacer layer. A first conductive trace is printed on the first substrate, and the second conductive trace is printed on the second substrate, such that at least a portion of the traces overlap. Magnetic material is incorporated on one or both of the substrates. Upon application of the a magnetic field, the substrates flex toward one another causing the traces to contact each other to close the circuit, or vice versa, depending on the configuration of the switch.

A battery-operated electronic device, according to embodiments, can comprise one or more printed circuits, a battery, and one or more magnetically-actuated membrane switches for effecting the operation of the device. In one embodiment, in a rest state, a membrane switch is in an open position wherein the conductive traces are not in contact such that the circuit is open, and the electronic device is powered off. In another embodiment, in a rest state, the membrane switch is in a closed position wherein the conductive traces are in contact such that the circuit is closed and functioning, and is powered on. Upon application of a magnetic field, the membrane switch shifts from the rest state to the activated state, thereby closing or opening the circuit, respectively. Multiple configurations of electronic devices are found in which the “off” state, whether it be unpowered, “sleep mode,” or disabled, can be either with a given input of control signal “high” or “low,” thus corresponding to various configurations of the controlling membrane switch of being open or closed.

In a particular embodiment, in a rest state, the membrane switch is in a closed position such that a particular low power circuit is closed, and another higher power circuit is open, and the device is in a low-power state in which the device does not have enough power to operate or is deliberately suppressed from operation. Upon application of a magnetic field, the membrane switch is opened, such that that the higher power circuit is now closed, and the device operates as intended. In an alternative embodiment, the low power circuit is closed upon the presence of a magnetic field such that the device cannot operate, and upon removal of the magnetic field, the lower power circuit opens, allowing the higher power circuit to close such that the device operates.

A packaged assembly according to embodiments includes a product or item having an electronic device thereon, and a packaging material. The electronic device includes circuitry for powering the electronic device. The circuitry includes one or more magnetically-actuated membrane switches. The packaging includes one or more magnets of for actuating the membrane switches. When the item is packaged, the magnet is proximate the membrane switch such that the magnetic field of the magnet is strong enough to actuate the switch. When the switch of these embodiments is activated, i.e. when the magnet is present, the electronic device is inoperable. Upon removal of the magnet, such as by removal of the packaging, the switch returns to a rest state, which effects operation of the electronic device. This allows for the powering off or down of the electronic device of the item when packaged so as not to consume and waste significant battery power and also to comply with screening requirements.

The above summary is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1A depicts a membrane switch of the prior art in a rest state in which the circuit is open;

FIG. 1B depicts the membrane switch of FIG. 1A in a closed or actuated state in which the circuit is closed;

FIG. 2A is a magnetically-actuated membrane switch in a rest state in which the circuit is open, according to an embodiment of the invention;

FIG. 2B is the magnetically-actuated membrane switch of FIG. 2A in an actuated state in which the circuit is closed;

FIG. 3A is a magnetically-actuated membrane switch in a rest state in which the circuit is open, according to an alternative embodiment of the invention;

FIG. 3B is the magnetically-actuated membrane switch of FIG. 3A in an actuated state in which the circuit is closed;

FIG. 4a is a magnetically-actuated membrane switch in a rest state in which the circuit is open, according to yet another embodiment of the invention;

FIG. 4b is the magnetically-actuated membrane switch of FIG. 4a in an actuated state in which the circuit is closed;

FIG. 5a is a packaging assembly for a battery-operated electronic device in a low power or powered off state; and

FIG. 5b is the unpackaged battery-operated electronic device of FIG. 5b in an operational state.

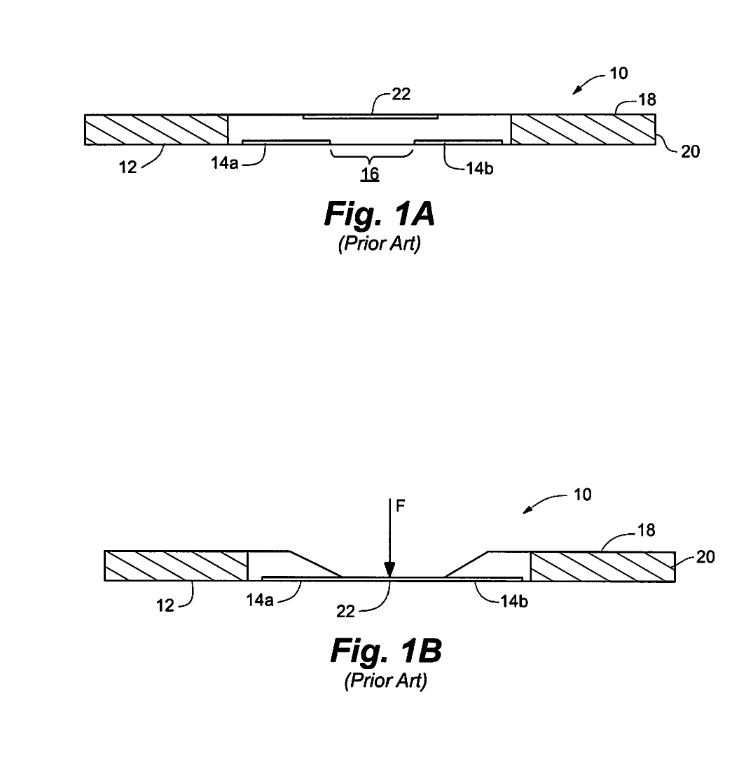

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

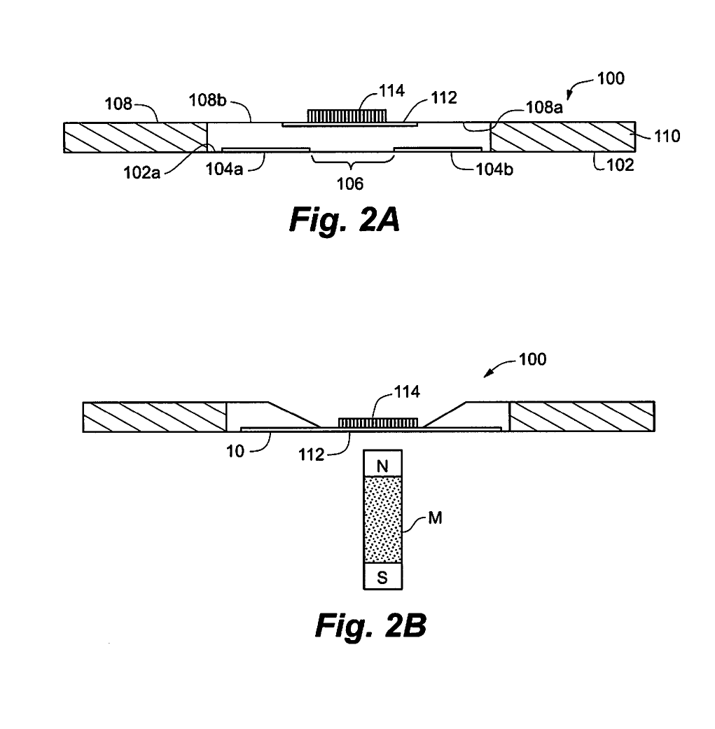

Referring to FIGS. 2A and 2B, a membrane switch 100 according to an embodiment generally can comprise a first flexible substrate 102 including a first conductive trace 104a and second conductive trace 104b printed or otherwise formed on a first surface 102a of the first flexible substrate 102, and separated by a gap 106. A second flexible substrate 108 spaced from the first flexible substrate 102 via a spacer layer 110 comprises a conductive shunt 112. Shunt 112 resides on a first surface 108a of substrate 108, opposing surface 102a so that shunt 112 faces traces 104a, 104b. A magnetic material 114, such as a ferromagnetic material, is incorporated into shunt 112 itself, is printed proximate the shunt 112 as shown in the figure, and or is incorporated into the first flexible substrate 102.

Throughout these descriptions, depending on the specific embodiment, the role of the magnet and the magnetic material can be interchanged or can also be substituted by the use of two magnets suitably oriented to create a mutually attractive or repulsive force, as desired for a particular construction.

Substrates 102 and 108 can comprise any of a number of flexible materials, such as polymeric materials including but not limited to, polyethylene terephthalate film (PET), polyethylene naphthalate (PEN), polyimide foil (PI), polypropylene, polyethylene, polystyrene, or any of a variety of polymer films or combinations thereof. In an alternative embodiment not shown, only the substrate having the magnetic material thereon is flexible. The rigid substrate comprises glass, wood, metal, PVC, silicon, epoxy resin, polycarbonate, or any of a variety of rigid materials.

Conductive traces 104a, 104b and conductive shunt 112 can comprise a printable or otherwise selectively deposited conductive material containing metallic particles such as, for example, but not limited to, silver, platinum, palladium, copper, nickel, gold, or aluminum or carbon or conductive polymer, or some combination thereof. The conductive metals or composites can be fine particulates or nanoparticulates in embodiments. The conductive material can be in the form of a printable conductive ink, toner, or other coating. In embodiments, electrically functional electronic inks are available from Henkel Corporation or DuPont Inc., for example. The traces and shunts can also be formed by other means.

Intricate patterns can be selectively printed or otherwise deposited to form traces 104a and 104b by any of a variety of printing methodologies, including, for example, any form of gravure, flatbed screen, lithography, screen, rotary screen, digital printing, and like print methods, or combinations thereof.

Magnetic material 114 can comprise a printable ferromagnetic material, such as, for example, a slurry incorporating ferromagnetic particles. One such material is available from the Rust-Oleum Corporation. Magnetic material 114 is printed or otherwise deposited or applied directly to shunt 112 as a layer sandwiched or arranged between shunt 112 and surface 108a, or proximate shunt 112 on the same surface 108a or an opposite surface 108b (as shown) of substrate 108. Magnetic material 114 can be printed using techniques similar to print traces 104a and 104b, or can be laminated, adhered, deposited, or otherwise applied to shunt 112 or substrate 108.

In an alternative embodiment, magnetic material 114 comprises a staple, foil, or other magnetic material applied to substrate 108. In yet another alternative embodiment, magnetic material 114 is adequately conductive such that a separate conductive material used to print traces 104a, 104b, and/or shunt 112 is not required.

Spacer layer 110 can comprises an expanded, insulative material, such as a closed- or open-celled foam layer, a fiber material, a polymeric film, or an adhesive layer. Spacer layer 110 is of sufficient thickness to prevent or inhibit contact of shunt 114 with one or both of traces 104a, 104b when the switch is in an “open” state such that the circuit is not complete and there is no path for current to flow. Spacer layer 110 can be printed, adhered, laminated, or otherwise applied directly to the same surface of substrate 108 as shunt 112, and/or substrate 102 as traces 104a, 104b. The regions where traces 104a, and 104b and shunt 112 are printed are substantially free of spacer layer 110 so as not to negatively impact the conductivity between the traces when electrically connected, i.e. when the circuit is closed.

Referring to FIG. 2A, membrane switch 100 is depicted in a rest or unmagnetized position. In this embodiment, the rest position comprises an open circuit, in which shunt 112 is spaced apart from, yet facing, traces 104a and 104b. No current is able to flow through the circuit.

Referring to FIG. 2B, membrane switch 100 is depicted in an actuated or magnetized position. A magnetic field is applied via a permanent magnet M, such as a rare earth magnetic. Alternatively, an electromagnet can be employed. Magnetic material 112 becomes magnetized and is thereby attracted to magnet M, flexing substrate 108 toward substrate 102. Shunt 112 contacts at least an end portion of both 104a and 104b, thereby completing the circuit such that current is allowed to flow through the circuit. Upon removal of the magnetic field, switch 100 returns to the rest state of FIG. 2A.

In an alternative embodiment to the embodiment depicted in FIGS. 2A and 2B, not shown, the shunt and traces are in contact in the rest position, and the circuit is closed and operating. Upon application of the magnetic field, the substrates are forced away from each other, e.g. because the magnet on the shunt layer opposes the magnetic field impressed upon the switch, and the circuit is opened no longer allowing current to flow.

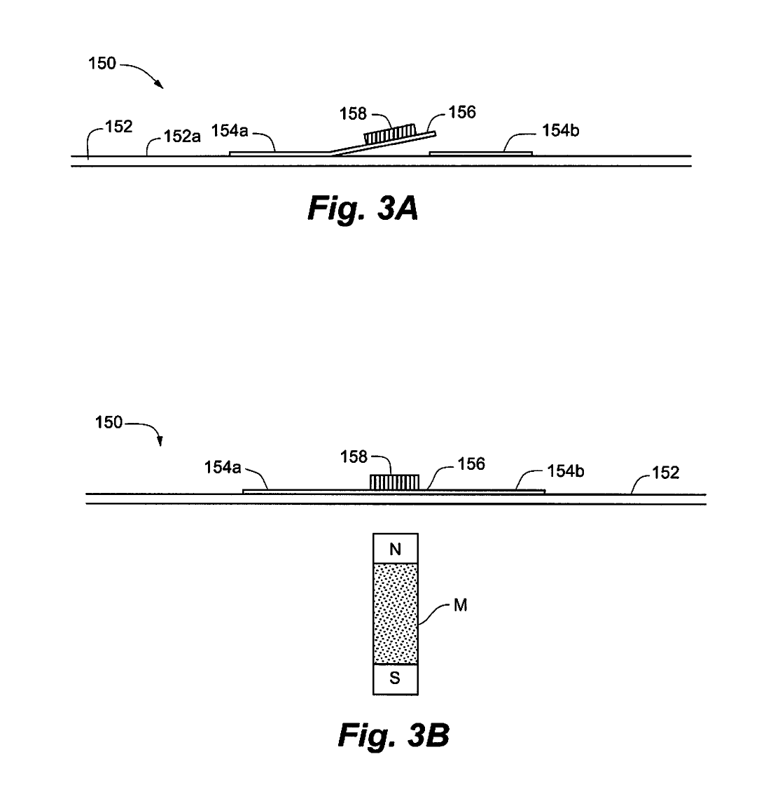

Referring to FIGS. 3A and 3B, in an alternative embodiment a magnetically-actuated membrane switch 150 comprises a single substrate 152. A first conductive trace 154a and a second conductive trace 154b are formed on a first surface 152a of substrate 152 via the materials and methodologies described above. A conductive flexing portion 156 or articulating arm of first conductive trace 154a, and formed of the same material as conductive trace 154a, also includes a magnetic material 158 deposited thereon, as described above.

Referring to FIG. 3A, membrane switch 150 is depicted in a rest or unmagnetized position. In this embodiment, the rest position comprises an open circuit, in which flexing portion 156 is in an “up” position such that trace 154a is not in contact with trace 154b. No current is able to flow through the circuit when applied. Referring to FIG. 3B, membrane switch 150 is depicted in an actuated or magnetized position. A magnetic field is applied via a magnet M as described above. Magnetic material 158 becomes magnetized and is thereby attracted to magnet M, causing flexing portion 156 to move toward substrate 152 and into contact with at least an end portion of trace 154b, thereby completing the circuit such that current is allowed to flow through the circuit when applied. Upon removal of the magnetic field, switch 150 returns to the rest state of FIG. 3A.

In an alternative embodiment to FIGS. 3A and 3B, and not specifically depicted, both traces include a flexing portion that raises or lowers to come into contact upon application or removal of a magnetic field.

In an alternative embodiment to the embodiment depicted in FIGS. 3A and 3B, not shown, the flexing portion is in contact with the second conductive trace in the rest position, and the circuit is closed and operating. Upon application of the magnetic field, the flexing portion is forced up and away from the substrate, e.g. because the magnet on the switch material opposes the external magnet, and the circuit is opened no longer allowing current to flow.

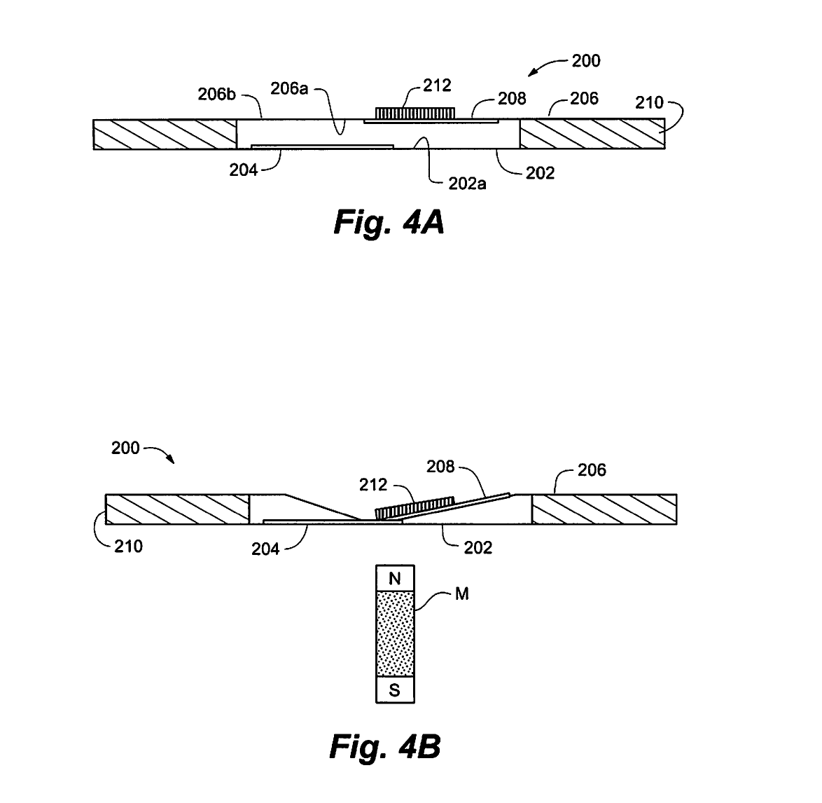

Referring to FIGS. 4A and 4B, in yet another embodiment, a magnetically-actuated membrane switch 200 generally comprises a first substrate 202 having a first conductive trace 204 printed on a first surface 202a, and a second substrate 206 separated from the first substrate 202 via a spacer layer 210, and having a second conductive trace 208 printed on a first surface 206a, via the materials and methodologies described above. First and second conductive traces 204, 208 face each other.

A magnetic material 212 is applied to one or both of the substrates 202, 206 proximate traces 204, or 206 as described above. As shown in FIGS. 4A and 4B, magnetic material 212 is printed on a second surface 206b of second substrate 206, and directly above conductive trace 208. Alternatively, magnetic material 212 is a discrete layer sandwiched between trace 208 and surface 206a of substrate 206, or is one and the same as trace 208, as described above. (For clarity, in an embodiment as described here, first surface 202a and second surface 206b are described differently than as commonly referred-to in the printing industry.)

Referring to FIG. 4A, membrane switch 200 is depicted in a rest or nonmagnetized position. In this embodiment, the rest position comprises an open circuit, in which first conductive trace 204 is separated from second conductive trace 208 via spacing layer 210. No current is able to flow through the circuit. Referring to FIG. 4B, membrane switch 200 is depicted in an actuated or magnetized position. A magnetic field is applied via a magnet M as described above. Magnetic material 212 becomes magnetized and is thereby attracted to magnet M, causing second substrate 206 with second conductive trace 208 to move toward first substrate 202 with first conductive trace 204. Second conductive trace 208 contacts at least an end portion of first conductive trace 204, thereby completing the circuit such that current is allowed to flow through the circuit when applied. Upon removal of the magnetic field, switch 200 returns to the rest state of FIG. 4A.

In an alternative to the embodiment depicted in FIGS. 4A and 4B, and not specifically depicted, the traces are in contact in the rest position, and the circuit is closed and operating. Upon application of the magnetic field, the substrates, and therefore the traces, are forced away from each other, e.g. because the magnet on the flexible layer 206 opposes the magnet M, and the circuit is opened and no longer allowing current to flow.

Due to the simplicity of the structures of the magnetically-actuated membrane switches according to embodiments, it can be economically viable or feasible to incorporate such devices within the flexible printed electronic circuitry of a device for controlling one or more parts of the electronic circuitry to effect operation of the device. For example, the switches can be printed in-line with the printing of other circuitry components, such as batteries, resistors, transistors, antennas, and the like, of an electronic device. This allows the incorporation of printed electronic devices in a variety of applications which were previously economically infeasible.

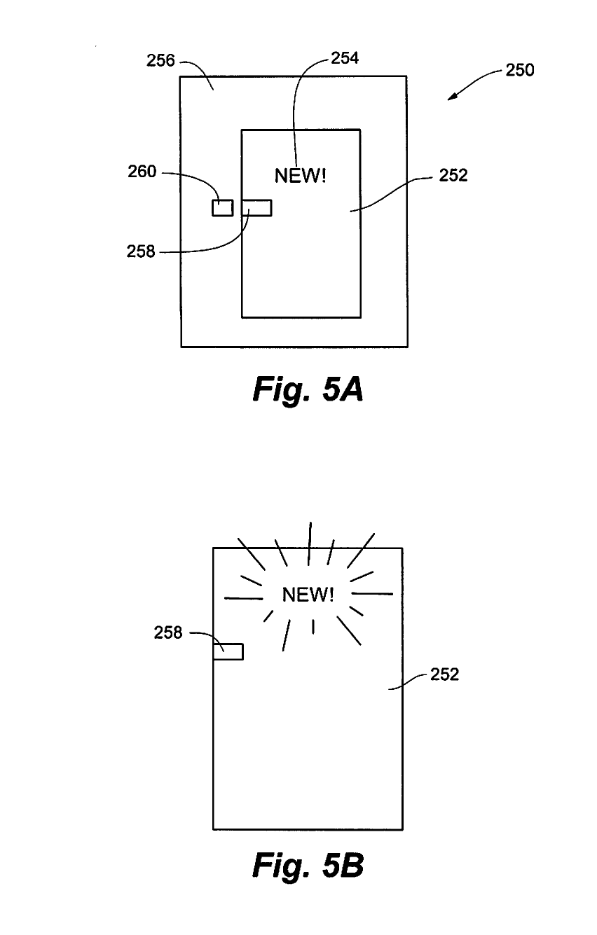

In particular a packaging application incorporating a membrane switch according to embodiments, allows an object or electronic device to remain unpowered or in a low power state during storage and/or transport, or until use. In one embodiment, and referring to FIGS. 5A and 5B, a packaging assembly 250 includes an item 252 having an electronic device 254 thereon, such as an electronic display or graphics, and a packaging material or wrap 256. One or more magnetically-actuated membrane switches 258, according to embodiments described above, are incorporated into the circuitry of device 254. A magnet 260 can be incorporated into packaging material 256.

Referring to FIG. 5A, when item 252 is packaged in packaging material 256, magnet 260 is proximate membrane switch 258 of item 252 such that the magnetic field produced by magnet 260 is strong enough to activate and maintain switch 258 in an activated state. Referring to FIG. 5B, upon removal or shifting of packaging material 258, such as after transport and/or storage of assembly 200, magnet 260 is moved away from switch 258, so that switch 258 moves to its rest or unactivated state, causing device 254 to operate.

In one embodiment, switch 258 is closed when in a rest position, causing the device 254 to operate. When packaged within packaging material 256, magnet 260 biases switch 258 into an open position, causing device 254 to be powered down or off, so as not to waste battery power. Upon removal of packaging material 256, switch 258 returns to the rest position, closing the circuit, thereby powering up device 254.

In an alternative embodiment, switch 258 is incorporated into a low power circuit that, when closed, does not provide enough energy to operate device 254 or maintains a potential sufficient to restrain the circuit from operation. In this embodiment, switch 258 is open in a rest position, thereby directing current to flow through a separate, higher power circuit in the circuitry of device 254, enabling operation of device 254. When packaged within packaging material 256, magnet 260 biases switch 258 into a closed position, causing any current to flow through this low power circuit, such that device 254 is unable to operate, so as not to waste battery power. Upon removal of packaging material 256, switch 258 returns to the rest position, thereby opening the circuit and causing flow through the higher power circuit to power up device 254.

While the maintenance of a switch position which controls the operation of a contained electronic device is herein described in terms of the use of a magnetically actuated switch, it is possible to achieve the same result with a conventional mechanically actuated membrane switch in a packaged assembly. In such an embodiment, the deformation of the switch to achieve the desired state must be impressed with a mechanical force. Such force could be applied, for example, by the use of a pressure force applied by means of an embossed, formed, inserted, or otherwise raised location on packaging kept in sufficient tension applied during the wrapping process to keep the switch deformed or impressed until the packaging is removed.

Embodiments discussed herein with respect to particular open and closed circuit configurations or other positions of particular elements can vary in these and other embodiments, i.e., can be reversed, exchanged between embodiments, or otherwise implemented. Thus, the particular embodiments given herein are not to be considered as limiting. Moreover, certain features and/or elements discussed or depicted herein with respect to any particular embodiments can be exchanged, combined or reconfigured with other features and/or elements of other devices. Those skilled in the art can appreciate these and other characteristics which can be implemented in ways other than those specifically depicted and/or described while remaining consistent with the concepts and implementations of various embodiments.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be formed or combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

What is claimed is:

1. A magnetically-activated membrane switch comprising:
a first substrate including:
a first conductive trace,
a second conductive trace, and
a gap separating the first conductive trace and the second conductive trace;
a second substrate including:
a conductive shunt comprising a magnetic material, the conductive shunt positioned opposite the gap; and
a space layer separating the first substrate and the second substrate,
wherein upon application of a magnetic field, the conductive shunt is shiftable between a closed circuit position wherein the conductive shunt bridges the gap and contacts at least a portion of the first conductive trace and at least a portion of the second conductive trace, and an open circuit position wherein the shunt is spaced apart from at least one of the first conductive trace or the second conductive trace.

2. The magnetically-activated membrane switch of claim 1, wherein the conductive shunt is configured to shift to the closed circuit position upon application of the magnetic field.

3. The magnetically-activated membrane switch of claim 1, wherein the conductive shunt is configured to shift to the open circuit position upon application of the magnetic field.

4. The magnetically-activated membrane switch of claim 1, wherein at least one of the first conductive trace, the second conductive trace, the magnetic material, or the spacer layer is formed by a printing technique or deposition technique.

5. The magnetically-activated membrane switch of claim 4, wherein the printing technique is at least one of gravure, flatbed screen, lithography, screen, rotary screen, digital printing, or combinations thereof.

6. The magnetically-activated membrane switch of claim 1, wherein at least one of the first conductive trace, the second conductive trace, the magnetic material, or the spacer layer is formed by a printing technique or deposition technique.

7. The magnetically-activated membrane switch of claim 1, wherein at least one of the first substrate or the second substrate are flexible and comprise at least one of polyethylene terephthalate film (PET), polyethylene naphthalate (PEN), polyimide foil (PI), polypropylene, polyethylene, polystyrene, polymer film, or combination thereon.

8. The magnetically-activated membrane switch of claim 1, wherein the magnetic material comprises at least one of a ferromagnetic particle slurry, a staple, a foil, or combinations thereof.

9. The magnetically-activated membrane switch of claim 1, wherein the spacer layer comprises open-celled foam, a fiber material, a polymeric film, and adhesive, or combinations thereof.

10. A magnetically-activated membrane switch comprising:
a substrate:
a first conductive trace formed on a surface of the substrate, the first conductive trace including an articulating arm;
a second conductive trace formed on the surface of the substrate proximate the articulating arm; and
a magnetic material operably coupled to the articulating arm,
wherein upon application of a magnetic field, the articulating arm is configured to articulate between a raised position having no contact with the second conductive trace, and a lowered position wherein the articulating arm contacts at least a portion of the second conductive trace.

11. The magnetically-activated membrane switch of claim 10, wherein the articulating arm is configured to articulate to the lowered position upon application of the magnetic field.

12. The magnetically-activated membrane switch of claim 10, wherein the articulating arm is configured to articulate to the raised position upon application of the magnetic field.

13. The magnetically-activated membrane switch of claim 10, wherein the second conductive trace further comprises a second conductive trace articulating arm configured to articulate between contacting at least a portion of the first conductive trace articulating arm and having no contact with the first conductive trace articulating arm.

14. A magnetically-activated membrane switch comprising:
a first substrate including a first conductive trace;
a second substrate including a second conductive trace;
a magnetic material operably couples to at least one of the first conductive trace or the second conductive trace; and
a spacer layer separating the first substrate and the second substrate,
wherein upon application of a magnetic field, at least one of the first conductive trace or the second conductive trace is configured to flex between a closed circuit position wherein at least one of the first or second conductive traces are flexed toward the other and the first conductive trace contacts at least a portion of the second conductive trace, and an open circuit position wherein the first conductive trace and the second conductive trace are spaced apart by at least a portion of the spacer layer.

15. The magnetically-activated membrane switch of claim 14, wherein at least one of the first conductive trace or the second conductive trace is configured to flex to the closed circuit position upon application of the magnetic field.

16. The magnetically-activated membrane switch of claim 14, wherein at least one of the first conductive trace of the second conductive trace is configured to flex to the open circuit position upon application of the magnetic field.

17. The magnetically-activated membrane switch of claim 14, wherein at least one of the first substrate or the second substrate are flexible and comprise at least one of polyethlene terephthalate film (PET), polyethylene naphthalate (PEN), polyimide foil (PI), polypropylene, polyethylene, polystyrene, polymer film, or combination thereof.

18. An electronic device comprising:
at least one printed circuit;
a battery configured to power the at least one printed circuit;
a magnetically-activated membrane switch configured to affect operation of the at least one printed circuit, the magnetically-activated membrane switch comprising:
a first conductive trace,
a second conductive trace, and
a magnetic material operably coupled to at least one of the first conductive trace or the second conductive trace,
wherein the magnetically-activated membrane switch is configured to shift, upon application of a magnetic field, between a rest state in which the first conductive trace is not in contact with the second conductive trace and power is not provided to the at least one printed circuit, and an activated state in which the first conductive trace is in contact with the second conductive trace and power is provided to the at least one printed circuit.

19. The electronic device of claim 18, further comprising a second printed circuit, wherein the battery is further configured to power the second printed circuit, and wherein when the magnetically-activated membrane switch is in the rest state, power is provided to the second printed circuit.

20. The electronic device of claim 19, wherein the at least one printed circuit is a high-power circuit and the second circuit is a low-power circuit.

21. The electronic device of claim 18, wherein the magnetically-activated membrane switch is configured to shift to the rest state upon application of the magnetic field.

22. The electronic device of claim 18, wherein the magnetically-activated membrane switch is configured to shift to the activated state upon application of the magnetic field.

23. A packaging assembly comprising:
an electronic device including:
a printed circuit, and
a magnetically-activated membrane switch configured to affect operation of the printed circuit; and
a packaging material comprising at least one magnet configured to generate a magnetic field to actuate the magnetically-activated membrane switch.

24. The packaging assembly of claim 23, wherein the magnetically-activated membrane switch comprises:
a first conductive trace,
a second conductive trace, and
a magnetic material operably coupled to at least one of the first conductive trace or the second conductive trace,
wherein the magnetically-activated membrane switch is configured to shift, upon application of the magnetic field from the at least one magnet, between a rest state in which the first conductive trace is not in contact with the second conductive trace and power is not provided to the printed circuit, and an activated state in which the first conductive trace is in contact with the second conductive trace and power is provided to the printed circuit.

25. The packaging assembly of claim 24, further comprising a battery configured to power the printed circuit.

26. The packaging assembly of claim 25, further comprising a second printed circuit, wherein the battery is further configured to power the second printed circuit, and wherein when the magnetically-activated membrane switch is in the rest state, power is provided to the second printed circuit.

27. The packaging assembly of claim 23, wherein the magnetic field actuates the magnetically-activated membrane switch to a rest state wherein the power is not provided to the printed circuit.

28. The packaging assembly of claim 23, wherein the magnetic field actuates the magnetically-activated membrane switch to an activated state wherein the power is provided to the printed circuit.
